(19) United States
(12) Patent Application Publication
(10) Pub. No.: US 2018/0017725 A1
(43) Pub. Date: Jan. 18, 2018

(54) Cooling Fan

(71) Applicant: Guangzou Zeta Model Aircraft Technology Co., Ltd., Guangdong (CN)

(72) Inventor: Anding FANG, Guangdong (CN)

(21) Appl. No.: 15/618,095

(22) Filed: Jun. 8, 2017

(30) Foreign Application Priority Data
Jul. 13, 2016 (CN) 201620750058.2

(51) Int. Cl. F21V 8/00; F21V 19/00; F21V 33/00

(52) U.S. Cl. CPC G02B 6/0001; F21V 33/0096; F21V 19/003; F21Y 2115/10; F21Y 2105/18

(57) ABSTRACT

A cooling fan, having a base, a fan, a light-guiding circle and a PCB light ring; the base has a cylindrical receiving space in the middle thereof, one end surface of the base has a pivot bracket, the fan is mounted on the pivot bracket and provided in the cylindrical receiving space; the base is provided thereon with an annular groove body surrounding the cylindrical receiving space, the depth direction of the annular groove body is the axial direction of the cylindrical receiving space, the width direction of the annular groove body is the radial direction of the cylindrical receiving space, the light-guiding circle and the PCB light ring are relatively fixed and mounted in the annular groove body. The PCB light ring is mounted in the annular groove body. The light emitted from the PCB light ring may penetrate the light-guiding circle and spread about.

### BACKGROUND OF THE INVENTION

The utility model relates to a cooling device, and specifically to a cooling fan.

With the advent of the era of science and technology, electronic products can be found in every aspect of people's daily life. Moreover, because the electronic products are becoming increasingly light, thin, short and small, making the temperature of the electronic elements within the products also increasingly easy to increase; however, in a high temperature environment the electronic elements can easily have its effectiveness reduced. Therefore, manufacturers develop a fan to speed up the cooling; however, with the popularity of the fan and the novel and unique design of the electronic products, the electronic product with a transparent or translucent shell and other design shell is provided; however, the appearance of a cooling device in the prior art does not have any change and has been more monotonous. Therefore, the manufacturers improve the appearance of the cooling device by mounting a light emitting element on a blade of the fan, with a light source emitted from a light-emitting element, the appearance changes in glare, a text or a pattern are formed, so as to improve the appearance of the fan.

However, a power source is conducted to the light-emitting element above the fan through members such as an axle center, a bearing, a conductive sheet, or a spring, this conduction method makes the conduction efficiency of the power source poor, furthermore, the internal structure of the fan is complex, therefore, the fan in the prior art has the disadvantages of the increased number of members, a large number of assembly steps, long manufacturing time, high product cost and the like. In addition, the conventional light-emitting element is permanently fixed to the fan, therefore, a user cannot replace the light-emitting element, so if the user wants to replace the light-emitting element having different colors, they will fail to do so for the conventional cooling device. Therefore, the prior art remains to be improved.

### BRIEF SUMMARY OF THE INVENTION

The utility model aims at providing a cooling fan with the advantages of a simple structure and easy installation, to overcome the defects in the prior art.

In order to achieve the above objectives, the utility model adopts the following technical solution:

A cooling fan comprises a base, a fan, a light-guiding circle and a PCB (Printed Circuit Board) light ring; wherein the base is provided with a cylindrical receiving space at the middle thereof, one end surface of the base is provided with a pivot bracket, the fan is mounted on the pivot bracket and provided in the cylindrical receiving space; the base is provided thereon with an annular groove which surrounds the cylindrical receiving space, the depth direction of the annular groove body is the axial direction of the cylindrical receiving space, the width direction of the annular groove body is the radial direction of the cylindrical receiving space; the light-guiding circle and the PCB light ring are relatively fixed and mounted in the annular groove body.

Furthermore, the light-guiding circle is made of a transparent resin.

Furthermore, the PCB light ring comprises the PCB board and a plurality of LED lights connected to the PCB board, the PCB board has a circular shape, the width of the PCB board matches the width of the annular groove body, the LED light is connected to the end surface of the PCB board; the light-guiding circle is annular, the shape of the light-guiding circle matches the inner space of the annular groove body; the PCB light ring is provided at the bottom of the annular groove body, the light-guiding circle is embedded into the annular groove body from the upward side of the PCB light ring, the PCB light ring is fixed at the bottom of the annular groove body.

Furthermore, one surface of the PCB light ring, which is provided with the LED light, faces the light-guiding circle, and the other one thereof faces the bottom of the annular groove body.

Furthermore, the light-guiding circle is annular, the shape of the light-guiding circle matches the inner space of the annular groove body the inner wall of the light-guiding circle is provided thereon with a mounting groove provided in the circumferential direction, the depth direction of the mounting groove is the radial direction of the light-guiding circle, the width direction of the mounting groove is the axial direction of the light-guiding circle; the PCB light ring comprises the PCB board and a plurality of LED lights connected to the PCB board, the PCB board surrounds and forms a cylindrical shape, the width of the PCB board matches the width of the mounting groove, the LED light is connected to the inner side wall of the PCB board; the PCB light ring is mounted in the mounting groove.

In the utility model, the light-guiding circle is made of a transparent resin. The PCB light ring is mounted in the annular groove body through the light-guiding circle, the light emitted from the PCB light ring may emit around through the light-guiding circle. The utility model has the advantages of a simple structure, convenient installation, optimization in luminous effect and convenient replacement of the PCB light ring.

### BRIEF DESCRIPTION OF THE DRAWINGS

FIG. 1 is a schematic structural view of a cooling fan provided by Embodiment 1 of the utility model.

FIG. 2 is a schematic structural view of a cooling fan provided by Embodiment 2 of the utility model.

### DETAILED DESCRIPTION OF THE INVENTION

The technical solution of the utility model will be described in detail below with reference to the drawings and specific examples.

### Embodiment 1

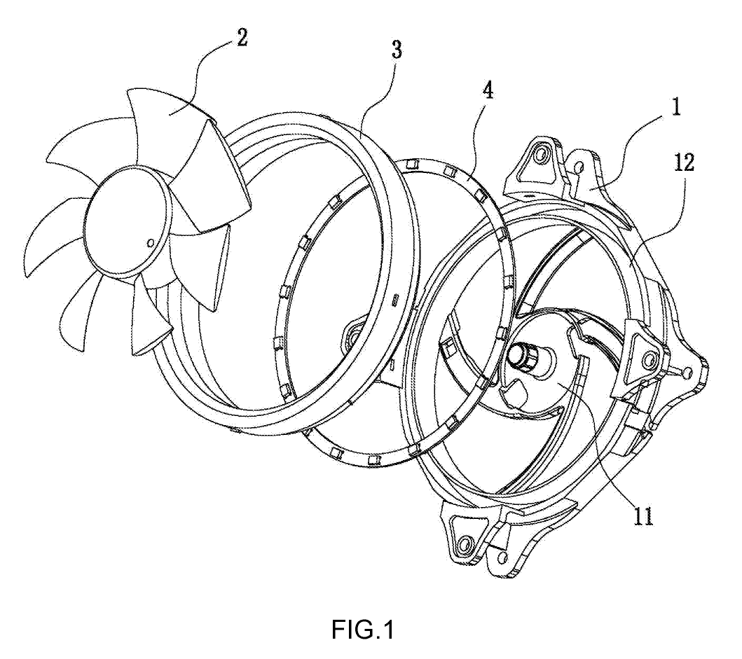

As shown in FIG. 1, the present embodiment provides a cooling fan comprising a base 1, a fan 2, a light-guiding circle 3 and a PCB light ring 4; wherein the base 1 is provided with a cylindrical receiving space at the middle thereof, one end surface of the base 1 is provided with a pivot bracket 11, the fan 2 is mounted on the pivot bracket 11 and provided in the cylindrical receiving space; the base 1 is provided thereon with an annular groove 12 which surrounds the cylindrical receiving space, the depth direction of the annular groove body 12 is the axial direction of the cylindrical receiving space, the width direction of the annular groove body 12 is the radial direction of the cylindrical receiving space; the light-guiding circle 3 and the PCB light ring 4 are relatively fixed and mounted in the annular groove body 12.

Furthermore, in the present embodiment, the PCB light ring 4 comprises the PCB board and a plurality of LED lights connected to the PCB board, the PCB board has a circular shape, the width of the PCB board matches the width of the annular groove body 12, the LED light is connected to the end surface of the PCB board; the light-guiding circle 3 is annular, the shape of the light-guiding circle matches the inner space of the annular groove body 12; the PCB light ring 4 is provided at the bottom of the annular groove body 12, the light-guiding circle 3 is embedded into the annular groove body 12 from the upward side of the PCB light ring 4, the PCB light ring 4 is fixed at the bottom of the annular groove body 12.

Wherein one surface of the PCB light ring 4, which is provided with the LED light, faces the light-guiding circle 3, and the other one thereof faces the bottom of the annular groove body 12.

In the utility model, the light-guiding circle is made of a transparent resin, the PCB light ring is mounted in the annular groove body through the light-guiding circle, the light emitted from the PCB light ring may emit around through the light-guiding circle.

### Embodiment 2

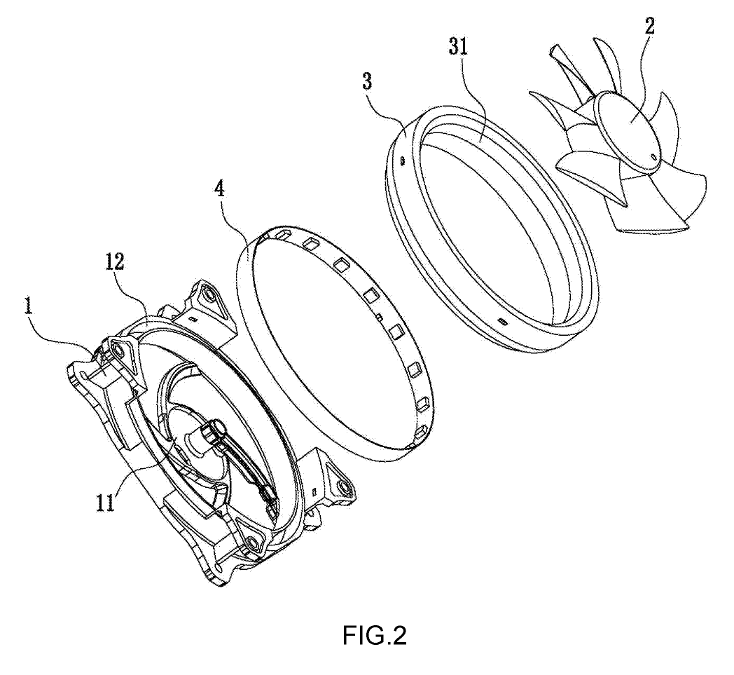

As shown in FIG. 2, the present embodiment provides a cooling fan comprising a base 1, a fan 2, a light-guiding circle 3 and a PCB light ring 4; wherein the base 1 is provided with a cylindrical receiving space at the middle thereof, one end surface of the base 1 is provided with a pivot bracket 11, the fan 2 is mounted on the pivot bracket 11 and provided in the cylindrical receiving space; the base 1 is provided thereon with an annular groove 12 which surrounds the cylindrical receiving space, the depth direction of the annular groove body 12 is the axial direction of the cylindrical receiving space, the width direction of the annular groove body 12 is the radial direction of the cylindrical receiving space; the light-guiding circle 3 and the PCB light ring 4 are relatively fixed and mounted in the annular groove body 12.

Furthermore, the present embodiment provides another embodiment of the light-guiding ring 3 and the PCB light ring 4, specifically, the light-guiding circle 3 is annular, the shape of the light-guiding circle matches the inner space of the annular groove body 12; the inner wall of the light-guiding circle 3 is provided thereon with a mounting groove 31 provided in the circumferential direction, the depth direction of the mounting groove 31 is the radial direction of the light-guiding circle 3, the width direction of the mounting groove 31 is the axial direction of the light-guiding circle 3; the PCB light ring 4 comprises the PCB board and a plurality of LED lights connected to the PCB board, the PCB board surrounds and forms a cylindrical shape, the width of the PCB board matches the width of the mounting groove 31, the LED light is connected to the inner side wall of the PCB board; the PCB light ring is mounted in the mounting groove.

In the utility model, the light-guiding circle is made of transparent resin. The PCB light ring is mounted in the annular groove body through the light-guiding circle. The light emitted from the PCB light ring may penetrate the light-guiding circle and spread around.

The above-mentioned embodiments have only described several embodiments of the utility model, and the description thereof is more specific and detailed, but it cannot be construed as limiting the scope of the utility model. It should be noted that it will be apparent to those skilled in the art that various modifications and improvements can be made without deviating from the spirit of the utility model, which fall within the protection scope of the present invention. Therefore, the protection scope of the utility model patent should be subject to the appended claims.

What is claimed is:

1. A cooling fan, comprising a base, a fan, a light-guiding circle and a PCB light ring; wherein the base is provided with a cylindrical receiving space at the middle thereof, one end surface of the base is provided with a pivot bracket, the fan is mounted on the pivot bracket and provided in the cylindrical receiving space; the base is provided thereon with an annular groove which surrounds the cylindrical receiving space, the depth direction of the annular groove body is the axial direction of the cylindrical receiving space, the width direction of the annular groove body is the radial direction of the cylindrical receiving space, the light-guiding circle and the PCB light ring are relatively fixed and mounted in the annular groove body.

2. The cooling fan according to claim 1, wherein the light-guiding circle is made of a transparent resin.

3. The cooling fan according to claim 1, wherein the PCB light ring comprises a PCB board and a plurality of LED lights connected to the PCB board, the PCB board has a circular shape, the width of the PCB board matches the width of the annular groove body, the LED light is connected to the end surface of the PCB board; the light-guiding circle is annular, the shape of the light-guiding circle matches the inner space of the annular groove body; the PCB light ring is provided at the bottom of the annular groove body, the light-guiding circle is embedded into the annular groove body from the upward side of the PCB light ring, the PCB light ring is fixed at the bottom of the annular groove body.

4. The cooling fan according to claim 3, wherein one surface of the PCB light ring, which is provided with the LED light, faces the light-guiding circle, and the other one thereof faces the bottom of the annular groove body.

5. The cooling fan according to claim 1, wherein the light-guiding circle is annular, the shape of the light-guiding circle matches the inner space of the annular groove body the inner wall of the light-guiding circle is provided thereon with a mounting groove provided in the circumferential direction, the depth direction of the mounting groove is the radial direction of the light-guiding circle, the width direction of the mounting groove is the axial direction of the light-guiding circle; the PCB light ring comprises the PCB board and a plurality of the LED lights connected to the PCB board, the PCB board surrounds and forms a cylindrical shape, the width of the PCB board matches the width of the mounting groove, the LED light is connected to the inner side wall of the PCB board; the PCB light ring is mounted in the mounting groove.
